(19) United States
(12) Patent Application Publication
(10) Pub. No.: US 2026/0131454 A1
(43) Pub. Date: May 14, 2026

(54) PROPRIOCEPTIVE ACTUATOR USING MAGNETORHEOLOGICAL FLUID CLUTCH APPARATUS

(71) Applicant: EXONETIK INC., Sherbrooke (CA)

(72) Inventors: Jean-Philippe LUCKING BIGUE, Sherbrooke (CA); Pascal LAROSE, Sherbrooke (CA); Jean-Sébastien PLANTE, Sherbrooke (CA)

(21) Appl. No.: 19/118,590

(22) PCT Filed: Oct. 11, 2023
(86) PCT No.: PCT/CA2023/051345

§ 371 Date: Apr. 4, 2025

Related U.S. Application Data
(60) Provisional application No. 63/414,965, filed on Oct. 11, 2022.

(51) Int. Cl. B25J 9/14; F16D 37/02

(52) U.S. Cl. CPC B25J 9/146; F16D 37/02

(57) ABSTRACT

A proprioceptive magnetorherological (MR) fluid actuator unit may include a bi-directional motor assembly. A MR fluid clutch apparatus connected to the bi-directional motor assembly, the MR fluid clutch apparatus controllable to transfer a variable amount of force from the bi-directional motor between at least two bodies using a reduction mechanism having a reduction ratio greater than 10:1. A processing unit is configured for: receiving the data from sensor(s), determining from the data that the bi-directional motor assembly has to accelerate or decelerate by a given value to control a relative speed between input and output of the MR fluid clutch apparatus to transmit a desired force between the two bodies, controlling the bi-directional motor to accelerate or decelerate toward the given value, and concurrently operating the MR fluid clutch apparatus to transmit the desired force between the bodies while maintaining a brake torque to inertia ratio over a haptic limit.

### TECHNICAL FIELD

The present application relates generally to magnetorheological (MR) fluid clutch apparatuses, and more particularly, to bodies, devices, systems, organs, etc using such apparatuses for dynamic control of motion in robots, active suspension systems or motion control devices.

### BACKGROUND OF THE ART

A moving robot, such as a legged robot, moving in a desired direction inevitably experiences perturbations in its motion or obstacles that may induce impacts or movements in other directions as well. This undesired motion often arises from disturbances in the medium through which the body evolves. For example, in a biomimetic robot, whether traveling by land, sea, or air, one such robot might encounter surface imperfections, bumps, waves, air pockets, and the like. At best, such random imperfection causes small, unexpected displacement of the body. This can also cause large impacts and undesired movement or acceleration of the body. For larger events, these random movements and accelerations can trigger an instability. Moreover, in some cases, a particularly violent acceleration may cause the body to lose control. Also, the body or the actuators can be damaged when submitted to acceleration or shocks. Even when stationary, there may be some residual vibration associated with the surface movements (e.g. standing on a moving platform). In motion, this residual vibration can cause wear of components.

A primary purpose of a body's actuation system is to provide control between the medium, such as the surface, and the body, in order to move a portion of the body in relation to the surface and to maintain or control the stability of the body, thus providing a path for transferring forces from the contact point(s) to the body. In applications where the body is a legged or wheeled body, the contact point is also used to change the speed or direction of the body. In a legged body, examples of some common robots are known generally as biomimetic robots like the MIT Cheetah or the Boston Dynamics Atlas and Spot.

In a legged robot, each leg assembly is connected to the robot chassis by one or more links. A link is defined as a substantially rigid member, the link interface to other link(s) or body with a joint or joints at an end(s), the joint(s) allowing a particular motion to take place. These links contribute to transferring the motion (or path) from the actuator to the environment of the body as it moves over the surface to induce movement. Some compliance and dampening may also be incorporated voluntarily into the link in order to partially decouple the actuators from the environment, improve stability or protect from high impact loads.

The design of proprioceptive actuator systems for actuating a leg or limb of the robot usually represents a compromise between the torque density, the bandwidth required to control the robot, backdrivability, inertia and the heat generation.

Generally, kinematically-induced leg reaction forces are created by the interaction between the leg and the surface, and/or inertial forces generated by the motion of the leg mass. The reaction forces occurring between the contact point of the leg and the surface or road are transferred via the links and actuation system to the body.

In a biomimetic robot application, controlled forces are introduced in the legs, such as by hydraulic or electric actuators, between the mass of the robot body and the effector that is in contact with the surface. The effector mass is the equivalent mass that reproduces the inertial forces produced by the motions of the parts of the robot not carried by the actuator. For legged robots, this primarily includes the foot assemblies, any mass of spring and dampers associated with the foot assemblies, and some portion of the mass of the links. The body mass is the mass of the parts of the robot carried by the actuation system, including the body or the chassis. Actuation systems may introduce forces that are independent of relative body motions and velocities.

In an active suspension application of a vehicle, controlled forces are introduced in the suspension, such as by hydraulic or electric actuators, between the sprung mass of the vehicle body and its occupants, and the unsprung mass of the wheel assemblies. The unsprung mass is the equivalent mass that reproduces the inertial forces produced by the motions of the parts of the vehicle not carried by the suspension system. This primarily includes the wheel assemblies, any mass dampers associated with the wheel assemblies, and some portion of the mass of the suspension links. The sprung mass is the mass of those parts of the vehicle carried by the suspension system, including the body. Active suspension systems may introduce forces that are independent of relative wheel motions and velocities.

Some robot system or active suspension systems rely on an electro-hydraulic actuation based on a pump and valve system adjusting the pressure of the hydraulic fluid in conventional hydraulic pistons. The electro-hydraulics approach is usually torque dense but does not have enough bandwidth to cope will all the spectrum of the induced perturbations and are thus inefficient. In order to resolve this problem, some systems include series-elastic actuation systems, which make use of a spring in series with a highly geared motor. The highly geared electric motor is a more efficient system, but may result in an increase the reflected inertia. The introduction of a spring adds compliance to the actuator in order to reduce impact forces (e.g., when a foot contacts the ground or when a vehicle wheel hits a pothole) induced by the high inertia, but also decreases the natural frequency of the system, providing less mechanical bandwidth, and reduced An alternative actuation system uses a quasi-direct drive approach, combining a high torque density motor with a low gearing ratio. This approach provides efficient (cost of transport) locomotion at high speeds from a performance standpoint. From an actuator standpoint, this approach is not as torque dense due to lower gearing, but still has relatively high inertia and is not as efficient as highly geared approaches, due to the increased copper losses of the larger motor.

Magnetorheological (MR) fluid actuators may solve most of the issues of the prior art. However, such MR fluid actuator systems have the disadvantage, as compared to standard actuation systems, that they are usually more complex and cost intensive due to the use of a larger number of components.

For that reason, there is still a need for a more economical active proprioceptive actuation system that performs with relatively high performance in contrast to prior art systems.

### SUMMARY

It is an aim of the present disclosure to provide novel active motion control systems using magnetorheological fluid clutch apparatuses.

It is a further an aim of the present disclosure to provide a method and system for increasing the gear ratio of a proprioceptive actuator without decreasing its controllability in the direction of the movement due to the reflected inertia of such an actuator.

It is a further aim of the present disclosure to provide novel robot actuator using magnetorheological fluid clutch apparatuses.

It is a still further aim of the present disclosure to use such systems in legged or humanoid robots.

It is a still further aim of the present disclosure to use such systems in vehicle or mobile devices active suspension systems.

Therefore, in accordance with a first aspect of the present disclosure, there is provided a proprioceptive magnetorherological (MR) fluid actuator unit, comprising: a bi-directional motor assembly; a reduction mechanism having a reduction ratio greater than 10:1; a MR fluid clutch apparatus connected to the bi-directional motor assembly, the MR fluid clutch apparatus controllable to transfer a variable amount of force from the bi-directional motor between at least two bodies using the reduction mechanism; at least one sensor for providing data indicative of a state of at least one of the bodies; a processing unit, and a non-transitory computer-readable memory communicatively coupled to the processing unit and comprising computer-readable program instructions executable by the processing unit for: receiving the data from the at least one sensor, determining from the data that the bi-directional motor assembly has to accelerate or decelerate by a given value to control a relative speed between input and output of the MR fluid clutch apparatus to transmit a desired force between the two bodies, controlling the bi-directional motor to accelerate or decelerate toward the given value, and concurrently operating the MR fluid clutch apparatus to transmit the desired force between the bodies while maintaining a brake torque to inertia ratio over a haptic limit.

Further in accordance with the first aspect, for example, the first body is a mass and the second body is a structure.

Still further in accordance with the first aspect, for example, the mass is sprung from the structure.

Still further in accordance with the first aspect, for example, the mass is controlled in order to achieve an active suspension.

Still further in accordance with the first aspect, for example, the bodies are links of a robot interconnected by a joint.

Still further in accordance with the first aspect, for example, the robot is a robot with limbs, and the links are part of the limb.

Still further in accordance with the first aspect, for example, the at least two bodies are interconnected by a rotational joint.

Still further in accordance with the first aspect, for example, the reduction mechanism includes a rotary-to-linear conversion for the proprioceptive MR fluid actuator unit to transmit a translational force between the bodies.

Still further in accordance with the first aspect, for example, the reduction mechanism includes a rotary-to-rotary arrangement for the proprioceptive MR fluid actuator unit to transmit torque between the bodies.

Still further in accordance with the first aspect, for example, the computer-readable program instructions are executable by the processing unit for causing a slippage in the MR fluid clutch apparatus at a brake torque to inertia ratio over the haptic limit.

Still further in accordance with the first aspect, for example, the haptic limit in N·m/kgm² is equal to Torque/(9×10⁻⁶×Torque^{1.66667}) for a torque in Nm for the proprioceptive MR fluid actuator unit.

Still further in accordance with the first aspect, for example, the haptic limit is 6300 N·m/kgm² for a torque of 75 Nm for the actuator unit.

Still further in accordance with the first aspect, for example, the MR fluid clutch apparatus has a torque-to-inertia ratio of at least 1×10⁶ N·m/kg·m².

Still further in accordance with the first aspect, for example, the reduction mechanism has a contact ratio of at least two between torque transferring elements.

Still further in accordance with the first aspect, for example, the reduction mechanism includes multiple load paths.

Still further in accordance with the first aspect, for example, the reduction mechanism is epicyclic gearing with at least two planets.

In accordance with another aspect of the present disclosure, there is provided a system for operating a magnetorherological (MR) actuator unit between bodies, comprising: an MR actuator unit including a bi-directional motor assembly, the bi-directional motor assembly operating within a first frequency range, and a MR fluid clutch apparatus connected to the bi-directional motor assembly to apply a variable amount of force from the bi-directional motor between at least two of the bodies, the MR fluid clutch apparatus operating within a second frequency range, the second frequency range being higher than the first frequency range; at least one sensor for providing data indicative of a state of at least one of the bodies; a processing unit; and a non-transitory computer-readable memory communicatively coupled to the processing unit and comprising computer-readable program instructions executable by the processing unit for: receiving the data from the at least one sensor; determining from the data that the bi-directional motor assembly has to accelerate or decelerate to control an amplitude and direction of a relative speed between input and output of the MR fluid clutch apparatus to transmit a desired force between the bodies; controlling the bi-directional motor to accelerate or decelerate toward the given value at the first frequency range, and concurrently reducing a torque transmission from the MR fluid clutch apparatus during a perturbation caused by an impact or a contact with the environment during which the torque transmission does not correspond to the desired force achievable by the control of the motor alone.

In accordance with yet another aspect, there is provided a system for operating proprioceptive actuator between a body and a effector, comprising: a bi-directional motor; a magnetorherological (MR) fluid clutch apparatus coupling the bi-directional motor to the body to apply force from the bi-directional motor to the effector; at least one sensor for providing data indicative of a state of the mass and/or of the structure; a processing unit; and a non-transitory computer-readable memory communicatively coupled to the processing unit and comprising computer-readable program instructions executable by the processing unit for: receiving the data from the at least one sensor; determining from the data a required torque amplitude to be generated by the bi-directional motor; keeping the bi-directional motor on even if the required torque amplitude is below a torque amplitude threshold to store mechanical momentum in the rotating components of the actuator, and activating the MR fluid clutch apparatus when the required torque amplitude is above a torque amplitude threshold to use the stored mechanical momentum.

In accordance with yet another aspect, there is provided a system for operating robot actuator between two bodies comprising: a bi-directional motor, the bi-directional motor operating within a first frequency range; a magnetorherological (MR) fluid clutch apparatus coupling the bi-directional motor to the body to apply force from the bi-directional motor to the effector, the MR fluid clutch apparatus operating within a second inertia range, the second inertia range being smaller than the first inertia range; at least one sensor for providing data indicative of a state of the mass and/or of the structure; a processing unit; and a non-transitory computer-readable memory communicatively coupled to the processing unit and comprising computer-readable program instructions executable by the processing unit for: receiving the data from the at least one sensor; determining from the data that the bi-directional motor switches direction; concurrently controlling the bi-directional motor to reducing a torque transmission from the MR fluid clutch apparatus when the force is not at the desired level.

### DESCRIPTION OF THE DRAWINGS

FIG. 1 is a schematic view of a generic magnetorheological (MR) fluid clutch apparatus, incorporating features of the present disclosure;

FIG. 2 is a sectioned schematic view of the MR fluid clutch apparatus of FIG. 1, in accordance with an embodiment;

FIG. 3 is a representation of a MR fluid actuator using a single motor and a single MR fluid clutch apparatus;

FIG. 4 is a representation of a MR fluid actuator using a single motor and double MR fluid clutch apparatuses;

FIG. 5 is a representation of two MR fluid actuators organized in a parallel path;

FIG. 6 is a schematic representation of a variant of a rotary MR fluid actuator;

FIG. 7 is a detailed representation of the rotary MR fluid actuator of FIG. 6;

FIG. 8 is a schematic representation of a variant of a linear MR fluid actuator using a rack and pinion coupled with a single motor and a single MR fluid clutch apparatus;

FIG. 9 are graphs showing positive torque transmission and a negative torque transmission using MR fluid clutching;

FIG. 10 is a schematic view of state-of-the-art EM actuators;

FIG. 11 is a schematic view of a proprioceptive EM actuator using a MR fluid clutch apparatus, in accordance with the present disclosure;

FIG. 12 is a graph showing actuator brake torque-to-inertia ratio and brake torque-to-mass ratio;

FIG. 13 is a table showing mass and inertia parameters of QDD and MR fluid actuators;

FIG. 14 is a state-of-the-art collaborative robot, showing typical dimensions thereof;

FIG. 15 is a schematic view of a lumped, one degree-of-freedom dynamic model;

FIG. 16 is a graph showing a no-load acceleration of a 1D model using QDD and MR fluid actuators with disks or drums;

FIG. 17 is a graph showing cost-of-torque of QDD and MR fluid actuators;

FIG. 18 is a sectional view of an embodiment of the proprioceptive EM actuator of FIG. 11 using a MR fluid clutch apparatus;

FIG. 19 is a comparative table of performances of a state-of-the-art proprioceptive QDD actuator performance VS the performance of a proposed proprioceptive actuator using a MR fluid clutch apparatus;

FIG. 20 is a schematic view of a lumped, one degree-of-freedom dynamic model using a linear actuator at one joint and a rotary actuator at the second joint;

FIG. 21 is a schematic view of a vehicle suspension equipped with a proprioceptive EM actuator using a MR fluid clutch apparatus, in accordance with the present disclosure;

FIG. 22 is a table and graphs representing the scaling law of haptic limits as a function of the torque of the actuator; and

FIG. 23 is a schematic view of a proprioceptive EM linear actuator using a MR fluid clutch apparatus, in accordance with the present disclosure.

### DETAILED DESCRIPTION

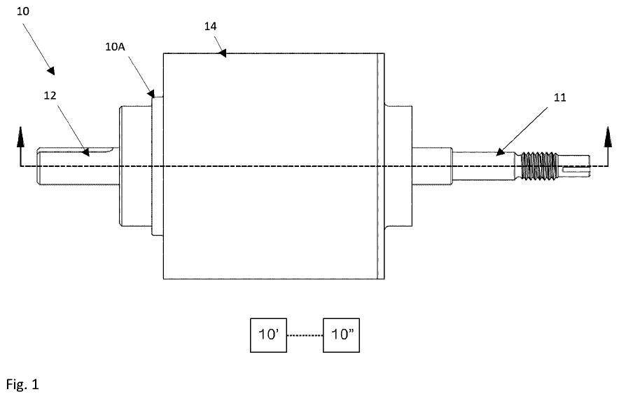

Referring to the drawings and more particularly to FIG. 1, there is illustrated a magnetorheological (MR) fluid clutch apparatus 10 configured to provide a mechanical output force based on a received input current. Therefore, each apparatus, system, device, etc described herein and featuring one or more MR fluid clutch apparatus 10 may be operated by way of a controller 10′, to provide suitable input current, based on sensor(s) 10″ that may receive data from any component in the apparatus, system, device, etc. The controller 10′ may include one or more processing unit; and a non-transitory computer-readable memory communicatively coupled to the processing unit(s) and comprising computer-readable program instructions executable by the processing unit(s) for operating the system, apparatus, device etc described herein. The MR fluid clutch apparatus 10 is shown as being of the type having collinear input and output shafts. However, the concepts described herein may apply to other configuration of MR fluid clutch apparatuses, for instance some with an input or output outer shell/casing for an output or input shaft, etc. The principles illustrated here will be performed using a MR fluid clutch apparatuses of drum type but could also be applied to a disc type MR fluid clutch apparatus. Magnet or magnets may also be introduced in the magnetic circuit in order for the MR fluid clutch apparatus 10 to provide a torque when not powered.

The MR fluid clutch apparatus 10 may provide an output force in response to an input current received from an operator, to transmit an input force and an output force based on the magnetization level of a magnetizable part in the magnetic circuit when there is no input current. The example MR fluid clutch apparatus 10 may have a stator 10A to which the MR fluid clutch apparatus 10 is connected to a structure. The MR fluid clutch apparatus 10 features driven member 11 and driving member 12 separated by gaps filled with an MR fluid, as explained hereinafter. The driving member 12 may receive rotational energy (torque) from a power device, such as a motor, with or without a transmission, such as a reduction gear box, etc.

According to an embodiment, the driving member 12 may be in mechanical communication with a power input, and driven member 11 may be in mechanical communication with a power output (i.e., force output, torque output). The stator 10A, the driven member 11 and the driving member 12 may be interconnected by bearings 12A and 12B. In the illustrated embodiment, the bearing 12A is between the stator 10A and the driving member 12, whereas the bearing 12B is between the driven member 11 and the driving member 12. Seals 12C may also be provided at the interface between the driven member 11 and the driving member 12, to preserve MR fluid between the members 11 and 12. Moreover, the seals are provided to prevent MR fluid from reaching the bearing 12B or to leak out of the apparatus 10.

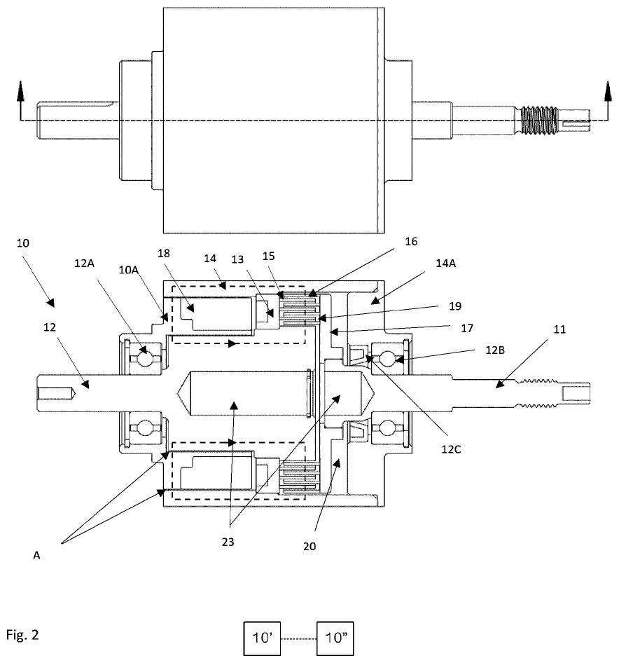

As shown with reference to FIGS. 2, drums are located circumferentially about the rotational axis CL. Some support must therefore extend generally radially to support the drums in their circumferential arrangement. In accordance with one embodiment, referring to FIG. 2, a low permeability input drum support 13 (a.k.a., radial wall) projects radially from a shaft of the driving member 12. The input drum support 13 may be connected to an input rotor 14 defining the outer casing or shell of the MR fluid clutch apparatus 10. The input rotor 14 may therefore be rotatably connected to the driven member 11 by the bearing 12B. In an embodiment, the input rotor 14 has an input rotor support 14A which forms a housing for the bearing 12B. According to an embodiment, the input rotor support 14A is an integral part of the input rotor 14, and may be fabricated as a single piece. However, this is not desirable as the input rotor support 14A is ideally made from a low permeability material and the input rotor is made from a high permeability material. As another embodiment, as shown in FIG. 2, the input rotor support 14A may be defined by an annular wall fabricated separately from a remainder of the input rotor 14, though both are interconnected for concurrent rotation.

Therefore, the shaft of the driving member 12, the input drum support 13 and the input rotor 14 rotate concurrently. In an embodiment, it is contemplated to have the outer shell of the MR fluid clutch apparatus 10 be part of the stator 10A, or of the driven member 11.

The input drum support 13 may support a plurality of concentric annular drums 15, also known as input annular drums. The input annular drums 15 are secured to the input drum support 13. In an embodiment, concentric circular channels are defined (e.g., machined, cast, molded, etc) in the input drum support 13 for insertion therein of the drums 15. A tight fit (e.g., force fit), an adhesive and/or radial pins may be used to secure the drums 15 to the input drum support 13. In an embodiment, the input drum support 13 is monolithically connected to the shaft of the driving member 12, whereby the various components of the driving member 12 rotate concurrently when receiving the drive from the power source.

The driven member 11 is represented by an output shaft, configured to rotate about axis CL as well. The output shaft may be coupled to various mechanical components that receive the transmitted power output when the clutch apparatus 10 is actuated to transmit at least some of the rotational power input.

The driven member 11 also has a one or more concentric annular drums 16, also known as output drums, mounted to an output drum support 17. The output drum support 17 may be an integral part of the output shaft, or may be mounted thereon for concurrent rotation. The annular drums 16 are spaced apart in such a way that the sets of output annular drums 16 fit within the annular spaces between the input annular drums 15, in intertwined fashion. When either of both the driven member 11 and the driving member 12 rotate, there is no direct contact between the annular drums 15 and 16, due to the concentricity of the annular drums 15 and 16, about axis CL.

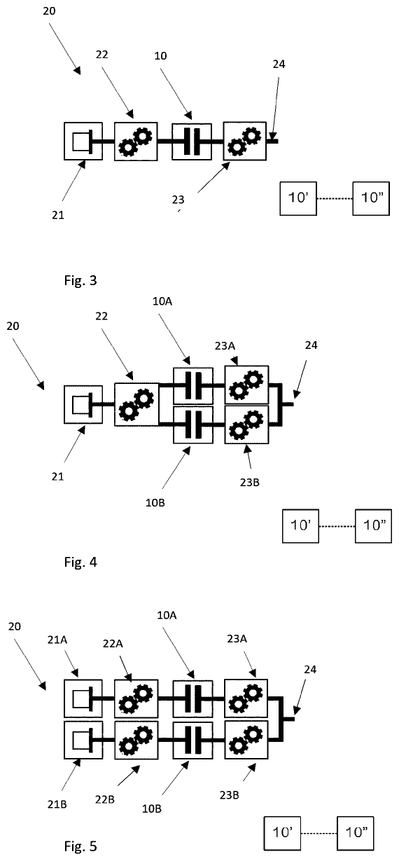

According to FIG. 3, a MR fluid actuator 20 (also known as a MR fluid actuator unit) is shown having a MR fluid clutch apparatus 10 of the type described above. The actuator is composed of a motor 21, an input gearbox 22, a MR fluid clutch apparatus 10, an output gearbox 23 and an output 24, though one or both of the gearboxes may be optional. Also, any MR fluid actuator 20 may be complement with sensors to indicate the position (e.g. position sensor), acceleration (e.g. acceleration sensor) or torque/force (e.g. torque or force sensor) generated by the MR fluid actuator 20. In a variant, in a basic configuration, a MR fluid actuator such as that shown as 20 has a motor 21 and a MR fluid clutch apparatus 10.

Another type of MR fluid actuator is shown on FIG. 4 and is composed of a single motor, an input gearbox 22, two MR fluid clutch apparatuses 10A and 10B, turning in opposite direction an applying antagonistic forces on the output 24, each through gearbox 23A and 23B.

Another type of MR fluid actuator is shown on FIG. 5 and is composed of two MR fluid actuators similar to the one of FIG. 3 working in parallel in order to apply a force on a single output 24. The first branch of actuation is composed of a motor 21A, an input gearbox 22A, a MR fluid clutch apparatus 10A, an output gearbox 23A driving the output 24. The first second branch of actuation is composed of a motor 21B, an input gearbox 22B, a MR fluid clutch apparatus 10B, an output gearbox 23B driving the same output 24. It is to be noted that for a reason of simplicity, the explanation provided is for the control of one degree of freedom, but multiple MR fluid actuators could be used to control multiple degrees of freedom of the body. Moreover, the multiple MR fluid clutch apparatuses could share the same power source, as is the case in FIG. 3 with both MR fluid clutch apparatuses 10 receiving the actuation power from the single motor 21, via a transmission 22. The transmission 22 is illustrated as featuring a gearbox but pulleys and belts may be used. Transmission 22 but may also be of other type such as a, chain and pinions, etc., only to name a few. Other devices can be used as variable force sources or biasing member.

The combination of a variable power source with the MR fluid clutch apparatus(es) 10 presents advantages of a hybrid system where one device or the other (or both simultaneously) can be controlled depending on the condition of operation. In an example where the power source is an electric motor, the electric motor speed and available torque can be controlled as well as the torque transmitted by the MR fluid clutch apparatus(es) 10.

This may increase the potential points of operation while increasing the overall performance or efficiency of the system. The output of the MR fluid clutches can be decoupled from the input. In some application, this can be useful to decouple the inertia from the input in order not to affect the time of response of the output.

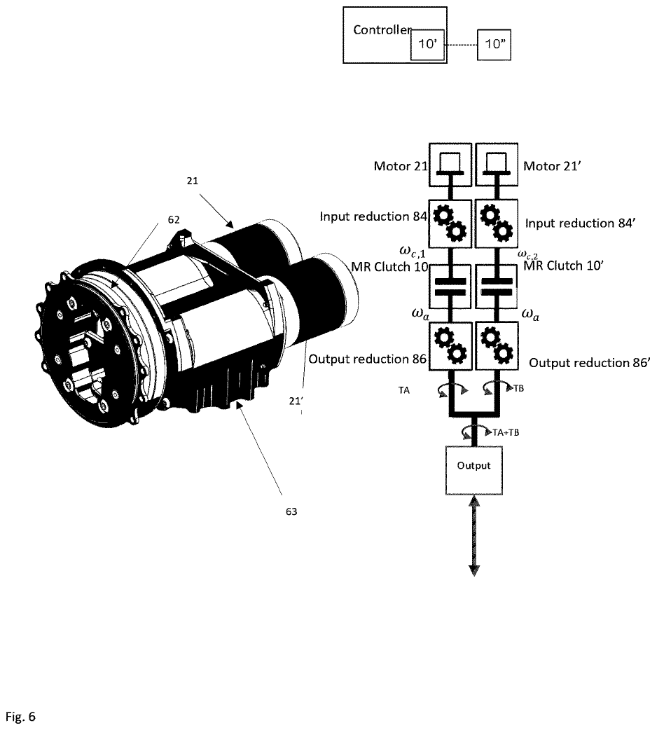

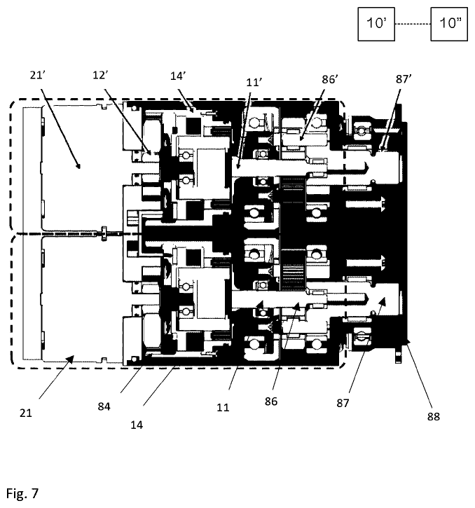

Referring to FIGS. 6 and 7, a configuration of FIG. 5 is illustrated, using an output reduction transmission 86 (e.g., bevel gears) and 86′, the output reduction mechanisms 86 and 86′ having each an output shaft 87 and 87′ that are connected to a single actuator output member 88. connecter to a single rotary output member 88. Rotary output is shown here but may also be replaced by a linear type of mechanism (e.g., ball screw, roller screw, rack and pinion, lever arm). The embodiment of FIGS. 6 and 7 are described in International patent application publication no. WO2021/155478A1, incorporated herein by reference. The embodiment of FIGS. 6 and 7, or of other embodiments described herein, may also be used as part of a robot joint.

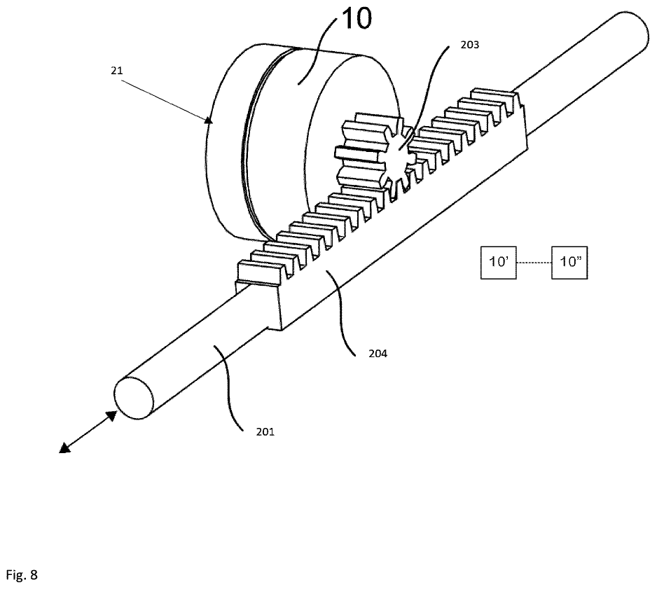

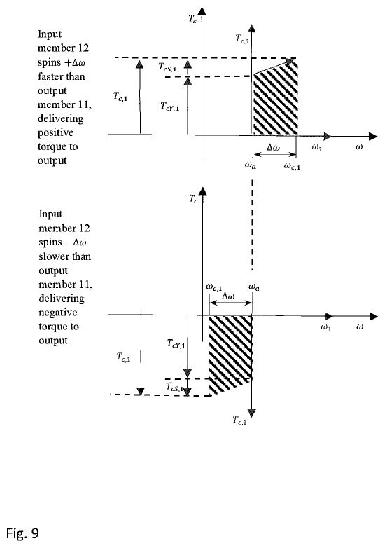

FIG. 8 is showing a single-motor single-clutch actuator system. A single MR fluid clutch apparatus 10 is used, with a pinion 203 on the structural link 201, acting as an MR brake or actuator by providing braking or actuation of the movement of the structural link 201 in the unbiased direction by applying a force on rack portion 204. Again, other types of linear mechanisms (e.g., ball screw, roller screw, rack and pinion, lever arm) may be used. The motor 21 may be a bi-directional motor in an embodiment. In such a MR motion control system, the motor 21 and the MR fluid clutch apparatus 10 is often having to reverse, a.k.a., change or switch in direction, (e.g., CW to CCW or vice versa, X translation to −X translation or vice versa). For example, an arrangement includes motor 21, optional input reduction mechanism 84 (embedded and not shown), and MR fluid clutch apparatus 10 where the input member 12 spins at a different speed than the output member 11 to provide a slipping condition decoupling the input inertia from the output. The slip direction within the MR fluid clutch apparatus 10 controls the direction of the output torque (positive or negative). A slip direction reversal may happen when the MR fluid clutch apparatus 10 slip changes direction, such as: A) when the input member 12 initially spins faster than the output member 11 and transitions to a state where it spins slower than the output member 11, reversing from a positive torque to a negative torque; B) when the input member 12 initially spins slower than the output member 11 and transitions to a state where it spins faster than the output member 11, reversing from a negative torque to a positive torque.

Live shifting the slip direction may allow a controller to maximise torque output and controllability. In the case of an arrangement featuring single motor 21 and single MR fluid clutch apparatuses, such as in FIG. 8, it may mean that the MR fluid actuator unit (i.e., one motor 21 and one MR fluid clutch apparatus 10) must reverse in order to switch. This live shifting mode of a MR fluid actuator requires the clutch input speed member 12, ω_{c,1} to either increase or decrease in order to switch side with respect to output speed, ωₐ. Controllability can potentially be lost during shifting, if shifting is too slow.

The speed difference during a reversal may be represented by ω_{c,2}−ω_{c,1}=2Δω assuming Δw slip is required within the MR fluid clutch apparatus 10 to produce a torque in the direction of Δw. Assuming constant acceleration and neglecting motor electrical response, the slip reversal time may be limited by the gearmotor acceleration (α_{gm}=T_{gm}/I_{gm}):

$$Δ t = \frac{2 Δ ω}{{α}_{gm}}$$

For reversals to be perceptible, motor reversal times required may be smaller than the actuator's required torque time response:

$$Δ t ≪ {τ}_{r}$$

where the actuator's time response is related to the (−3 dB desired force command of the application) actuator's blocked force bandwidth in Hz by:

$${τ}_{r} = \frac{0.35}{{f}_{3 db}}$$

Minimal gearmotor acceleration is thus needed for imperceptible slip shifts of given application:

$${α}_{g m} ≫ 5.7 Δω {f}_{3 dB}$$

If Δω=10i (in RPM, or Δω=1.05i in rad/s), and if the maximum humanly perceptible force bandwidth is 20 Hz, than the gearmotor's acceleration may be

$${α}_{g m} ≫ 7000 \frac{rad}{{s}^{2}} .$$

For imperceptible shifts, shifts should be done in the constant torque regime where acceleration is at a maximum. Moreover, input reduction-ratio's 84 may be maintained as low as possible since

$${α}_{g m} = {α}_{m} \cdot \frac{1}{{r}_{p}} .$$

Hence motor/input reduction-ratio's 84 selection is critical for seamless slip direction change. For example, the torque-to-inertia ratio of a given motor

$$4 \frac{rad}{{s}^{2}}$$

drops to

$$2 \frac{rad}{{s}^{2}}$$

when coupled with a rₚ=4:1 input reduction-ratio's 84 and may become perceptible. In contrast, other motor may be operated with input reduction-ratio's 84 rₚ=1:1 and have torque-to-inertia ratios in the ˜

$$160 \frac{rad}{{s}^{2}}$$

range, thus having strong potential for seamless shifts. The numbers used here are only provided for general illustration purposes and may not necessarily be reflecting real devices values.

As shown by the example, minimum gearmotor dynamics cannot always match system requirements. Antagonistic MR systems using two counter-rotating MR fluid actuator units like the one of FIG. 4 that always remain antagonistic do not exhibit reversal events since there is always one MR fluid clutch apparatus 10 slipping in each direction in relation to the output, therefore providing optimal motion control performance.

Motion control systems using only one motor 21 and one MR fluid clutch apparatus 10 like the one of FIG. 8, and reconfigurable motion control systems using multiples motor/clutch chains that can switch between antagonistic and combined operation, like the one of FIG. 6, must inevitably face reversal events, and are thus potentially impeded by the combination of motor 21 and input reduction mechanism 84 dynamics.

The present disclosure describes a method for minimizing controllability losses during impacts and reversals when the dynamics of a combination of motor 21 and input reduction mechanism 84 are slower than motion system requirements.

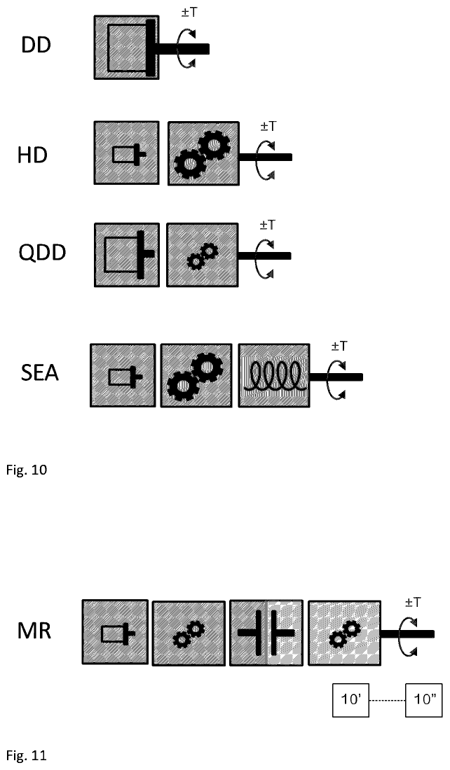

FIG. 10 shows schematic images of state-of-the-art electromagnetic (EM) actuators. A) shows a direct drive (DD) actuator, B) a highly geared actuator (HD), C) a quasi-direct drive (QDD), and D) a serial elastic actuator (SEA). The QDD actuator C) has a high torque density motor, a low gear ratio transmission and a low inertia output. For EM actuators, the Impact Mitigation Factor (IMF) is the factor that may be said to quantify the normalized inertial impedance of a floating-body robot, capturing the effects of actuator design to reduce impulsive forces at impact. For such QDD actuators, it may be said that the optimal actuator for a given mass may include a motor with the largest gap radius, within available space, and the smallest gear ratio as required by torque specification.

FIG. 11 is a schematic view of the proposed proprioceptive EM actuator using a MR fluid clutch apparatus 11, in accordance with the present disclosure. In state-of-the-art proprioceptive actuator like the QDD proposed in FIG. 10 C), the gear ratio may be limited in order not to generate too large forces when the end effector impacts the surface, the gear ratio typically less than 10:1. When an actuator is oversimplified, the reflected inertia of the effector is proportional to the inertia of the motor to the square of the gearbox ratio. For a given motor inertia, increasing the gearbox ratio will proportionally increase the torque but will increase the reflected inertia to the square. Hence, Torque/Inertia ratio will decrease faster than the increase of inertia. It is known that the inertia of a system is an important factor to limit the impact force of an end effector on a surface or on an object. For a given end effector speed, the lower the inertia of the end effector and the reflected inertia of the motor and gearbox combination, the lower the impact force will be. There may be an advantage to limiting this inertia. Because the inertia increases faster than the torque as the ratio is increased, there may be an incentive to limit the gearbox ratio, to limit the inertia of the system, to the detriment of the increase in the torque ratio. However, introducing a MR fluid clutch apparatus 10 in the chain may help to reach increased torque density without increasing the total inertia at the end effector. MR fluid clutch apparatuses, such as 10 in the various embodiments herein, are known to have a lower intrinsic inertia per unit of torque than an electric motor. Typically, for a given torque, the Torque/Inertia of a MR fluid clutch apparatus will be five times more than the one of an electric motor. Therefore, for a given torque and gearbox ratio, a MR fluid clutch apparatus may reflect roughly 25 times less inertia at the end effector. Having less inertia reflected at the output may present some advantage but this may also involve a higher gearing ratio between the motor and the end Effector.

An analysis is derived hereafter to understand the impact of gearing ratio on actuator performance and to compare QDD and MR fluid actuators, i.e., such as the one of FIG. 11 or other combinations of motor and MR fluid clutch apparatus. An actuator torque-to-mass, τ_{b}, and torque-to-inertia, α_{b}, can be expressed according to motor, clutch (if present), and gearing properties such that:
The torque-to-mass ratio (τ_{b}) of a QDD actuator is given by:

$${τ}_{b} = \frac{i}{\frac{1}{{τ}_{m}} + {K}_{τ} {i}^{2}} η \qquad ( 1 )$$

where τₘ is the motor torque-to-mass ratio, K_{τ} the gearing mass constant, i the gearing ratio and η the gearing efficiency such that:

$$η ( i ) = 0.9519 - 0.02 \; 489 ln ( i ) - 3.24 \times {10}^{- 5} i \qquad ( 2 )$$

The torque-to-mass ratio of a MR fluid actuator is given by:

$${τ}_{b} = \frac{i}{\frac{1}{{τ}_{m}} + \frac{1}{{τ}_{c}} + {K}_{τ} {i}^{2}} η \qquad ( 3 )$$

where τₘ is the motor torque-to-mass ratio, τ_{c} is the clutch torque-to-mass ratio, K_{τ} the gearing mass constant, i the gearing ratio and η the gearing efficiency.
The torque-to-inertia ratio of a QDD actuator is given by:

$${α}_{b} = \frac{1}{\frac{i}{{α}_{m}} + {K}_{α} {i}^{2}} η \qquad ( 4 )$$

where αₘ is the motor torque-to-inertia ratio, K_{α} the gearing inertia constant, i the gearing ratio and η the gearing efficiency.
The torque-to-inertia ratio of a MR fluid actuator is given by:

$${α}_{b} = \frac{1}{\frac{i}{{α}_{c}} + {K}_{α} {i}^{2}} η \qquad ( 5 )$$

where α_{c} is the clutch torque-to-inertia ratio, K_{α} the gearing inertia constant, i the gearing ratio and η the gearing efficiency.

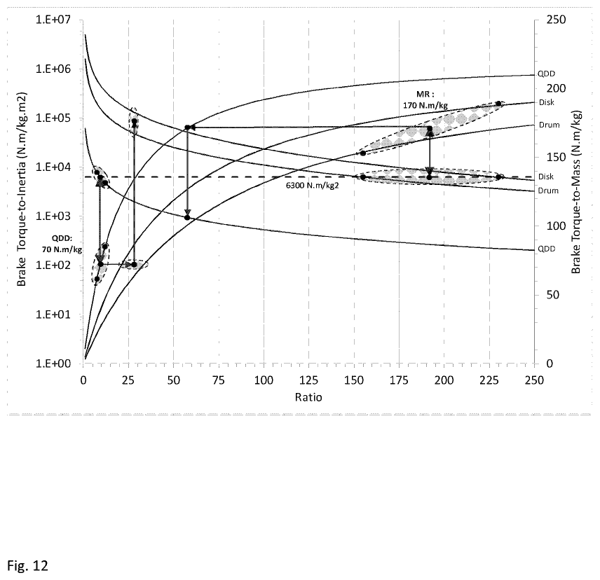

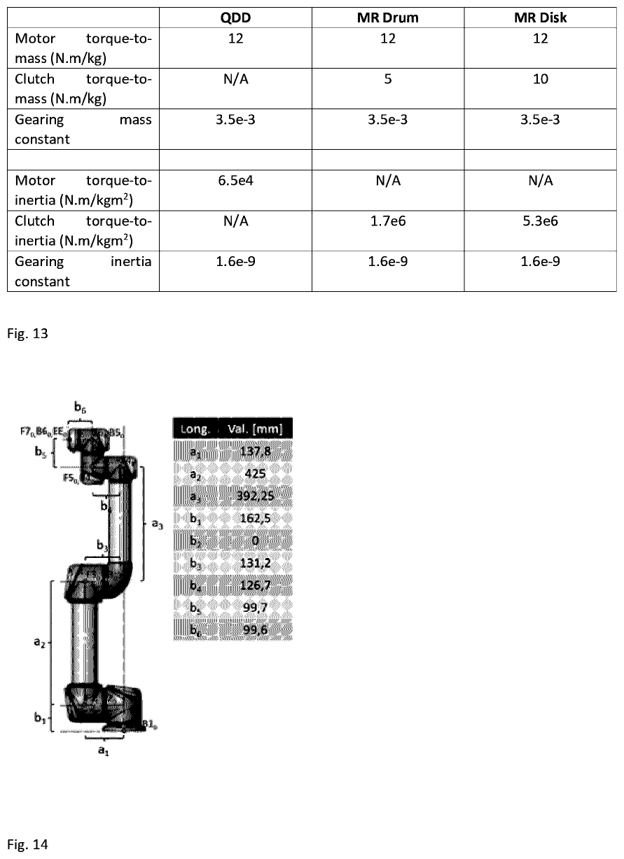

FIG. 12 shows torque-to-mass and torque-to-inertia ratios of QDD and MR fluid actuators as a function of the actuator gearing ratio. It shows actuator brake torque-to-inertia ratio (left) on a logarithmic scale, and brake torque-to-mass ratio (right). The curves for the MR fluid actuators are for MR fluid clutch apparatuses using drum (lower curve) and disk (higher curve) shear surfaces. Values are computed with parameters listed in FIG. 13. These parameters represent experimentally demonstrated, state-of-the art values for both QDD and MR fluid actuators.

Looking at FIG. 12, the QDD curves show 3 points on the left. These are actual design limits such as the Cheetah actuator (7.5:1 ratio) and a humanoid actuator (12:1) in the range of ˜75 Nm output torque. The middle point is the average of the two, and sets the horizontal dash line representing what can be set as an acceptable torque-to-inertia limit of 6300 N·m/kgm²

MR fluid actuators are bound to the quality of their MR fluid clutch apparatus. Two designs are illustrated, a robust and well proven drum-type clutch and a new high-performance disk clutch. Again the middle point between the two is the technology average. The MR fluid clutch apparatus 10 used in a proprioceptive MR fluid actuator may contribute to the performance of the actuator in having a high brake torque to inertia ratio, by having itself a torque to inertia ratio of at least 1.5×10⁶ N·m/kg·m². This ratio for the MR fluid clutch apparatus 10 can be achieved in different ways, such as by adjusting the overall area of shear surfaces, the dimensions of drums or discs (disks), the thickness and weight of the components. Another factor that can contribute to the high brake torque to inertia ratio of the proprioceptive MR fluid actuator is to provide suitable gearing. For example, the reduction mechanism in the proprioceptive MR fluid actuator unit of the present disclosure may have a low inertia gearing technology, that has more than one point of contact between gears (i.e., contact ratio of at least 2, the contact ratio being the average number of gear teeth in contact with one another as the gears are in operation). More than one point of contact can be achieved by using gears with more than one teeth in contact such as helical gearing, internal, helical or spiral gears and/or by using geartrain arrangements having more than one gear in contact such as epicyclic gearing. Thus, a combination of these design factors can assist in providing a high torque density to the proprioceptive MR fluid actuator unit, in spite of being highly geared.

It can be seen that MR fluid actuators can use gearing ratios of about 190:1 while still meeting the 6300 N·m/kgm² threshold. This is about 10 times higher gearing than QDD actuators. The benefit is that, for a same dynamic performance (torque-to-inertia), MR fluid actuators are lighter than QDD (e.g., 2.4 times as per 70 vs 170 N·m/kg), because of the higher gear ratios associated with MR fluid actuators.

Looking at the green arrows in FIG. 12: A) Starting from the left. MR fluid actuators need a gearing ratio of ˜30:1 to match the torque-to-mass of actual QDD with ratios of about ˜10:1. At ˜30:1, the torque-to-inertia of MR fluid actuators is about 15.9 times higher than the 6300 N·m/kgm² limit, leading to high quality of force capabilities akin to the best haptic inceptors. B) Starting from the right. QDD actuators need a gearing ratio of ˜60:1 to match the torque-to-mass of MR fluid actuators using ˜190:1. At ˜60:1, the torque-to-inertia of QDD actuators is 6.3 times lower than the 6300 N·m/kgm² limit, destroying quality of force to the level of traditional gearmotors.

This analysis demonstrate that it is difficult with current QDD technology to achieve high torque-to-mass ratios and high torque-to-inertia ratios. A better performance may be achieved with MR fluid actuators where a clutch is introduced to remove motor inertia from the picture, thereby allowing higher gearings. With the current state of technology, at ratios between ˜30:1 and ˜190:1, MR fluid actuators show both higher torque-to-mass and torque-to-inertia than QDD actuators which are limited to ratios of about ˜10:1.

As a result, in spite of adding an extra component, a MR fluid clutch apparatus, to an actuator system, and thus, adding weight, there actually results a lighter actuator with lower inertias when proper gearing ratios are used.

The impact of having both higher torque-to-mass and higher torque-to-inertia over QDD actuators on robotic systems is analyzed on a typical collaborative robot.

The robot arm illustrated in FIG. 14 represents an exemplary collaborative robot system. The kinematics of its three proximal joints connected by links a1, a2, and a3 also represent other typical collaborative robot systems such as humanoids (shoulder and hip) and animal robots (e.g. MIT Cheetah).

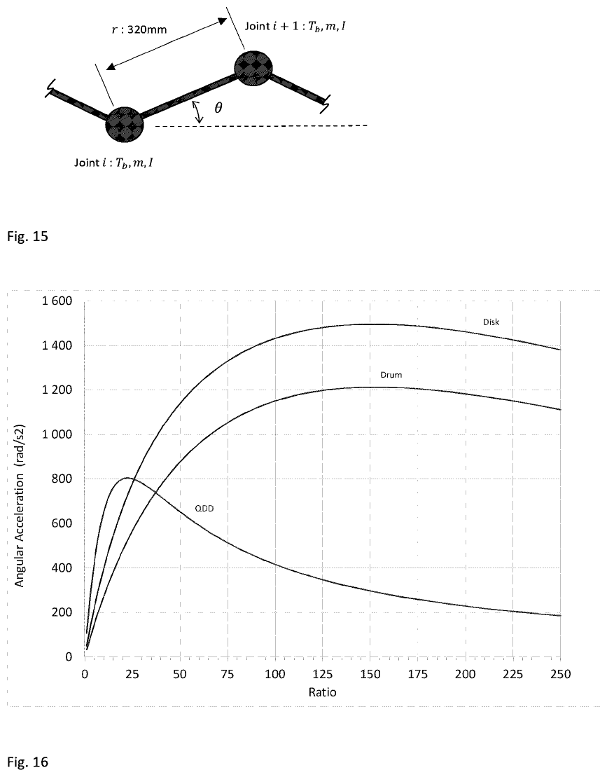

The three proximal joints are also the most demanding in terms of dynamic capabilities. A simplified, lumped, one degree-of-freedom dynamic model of the first three joints can be derived by considering only one link connected by two actuators such as shown in FIG. 15. Like for the robot arm of FIG. 14, the joints use identical actuators with a same rated brake torque T_{b}, mass m, and inertia I. The link is massless and its length is taken as the mean length of the first three joints (a1, a2, a3) that is 320 mm, as per FIG. 14.

A performance metric of the system's dynamics including actuators inertial and mass effects is the no-load acceleration of the link, that is, the maximum angular acceleration of the link, θ″, when a torque T_{b} is applied to joint i with no external load. The equation of motion of the link is:

$${T}_{b} = ( I + {mr}^{2} ) {θ}^{″} \qquad ( 6 )$$

which becomes after simplification:

$${θ}^{″} = ( {α}_{b} {T}_{b} ) / ( {T}_{b} + {α}_{b} {r}^{2} ) \qquad ( 7 )$$

where α_{b}=T_{b}/l is the actuator brake torque-to-inertia ratio and T_{b}=T_{b}/m is the actuator brake torque-to-mass ratio.

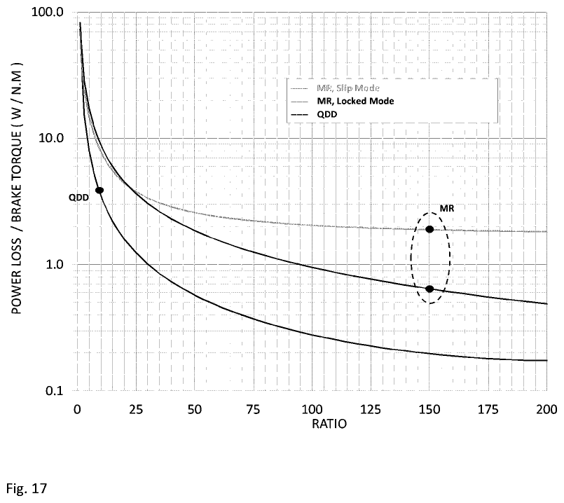

No-load accelerations of the 1D model using QDD and MR fluid actuators are plotted against gearing ratio in FIG. 16. Values of the table of FIG. 13 are used again to compute actuator brake torque-to-inertia and brake torque-to-mass ratios.

QDD have maximum no-load accelerations at ˜25:1, which cannot be reached in practice due to excessive torque-to-inertia (as per FIG. 12). At the current ratio limit of about 10˜1, QDD have maximum accelerations around 700 rad/s².

MR fluid actuators have maximum no-load accelerations at ˜150:1, which can be reached while having acceptable torque-to-inertia (as per FIG. 12). At ˜150:1, MR fluid actuators have maximum no-load accelerations between 1200 and 1500 depending on the clutch technology. The maximum no-load acceleration of MR fluid actuators is thus about 2 times that of QDD actuators.

The cross-over point where MR fluid actuators show better no-load accelerations than QDD is at ˜30:1 point, which is the same threshold where the torque-to-mass of MR fluid actuators becomes equal to that of QDD (as per FIG. 12).

The ability of using higher gearing has a direct consequence on energy consumption. As shown by design simulations in FIG. 17, at their limiting gearing of ˜10:1, QDD have a power consumption of about ˜4W/N·m. In contrast, at gearings of ˜150:1, MR fluid actuators have power consumption of ˜0.6 W/N·m when the MR fluid clutch is locked and ˜2 W/N·m when the MR fluid clutch is slipping. This results in about 6.7 times lower power consumption with locked clutch, and about 2 times with slipping clutch.

Therefore, when power must be supplied to the clutch's coil, and that power is lost when the MR fluid clutch apparatus is slipping, MR fluid actuators can counterintuitively exhibit lower power consumption than QDD actuators.

Then, the optimum total gear ratio of the proprioceptive actuator using a MR fluid clutch apparatus 10 will be higher than the QDD one, so typically over 30:1 and below 190:1. These ratios offer up to 15 times higher torque-to-inertia ratio, up to 2.4 times higher torque-to-mass ratio, and at least 2 times lower power consumption.

Then, the optimum total gear ratio of the proprioceptive actuator using a MR fluid clutch apparatus 10 will be higher than the QDD one, so typically over 10:1.

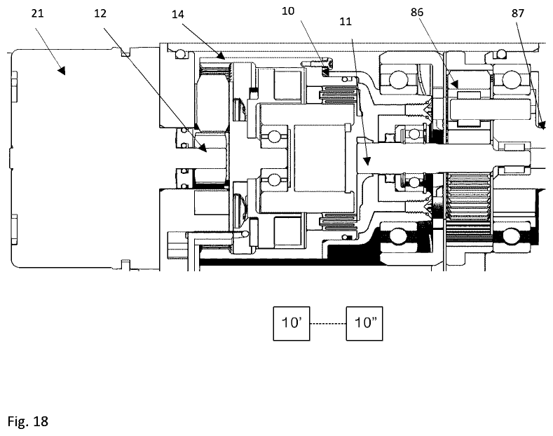

FIG. 18 shows a typical single motor single clutch proprioceptive actuator. The components are similar to the ones described in FIG. 7.

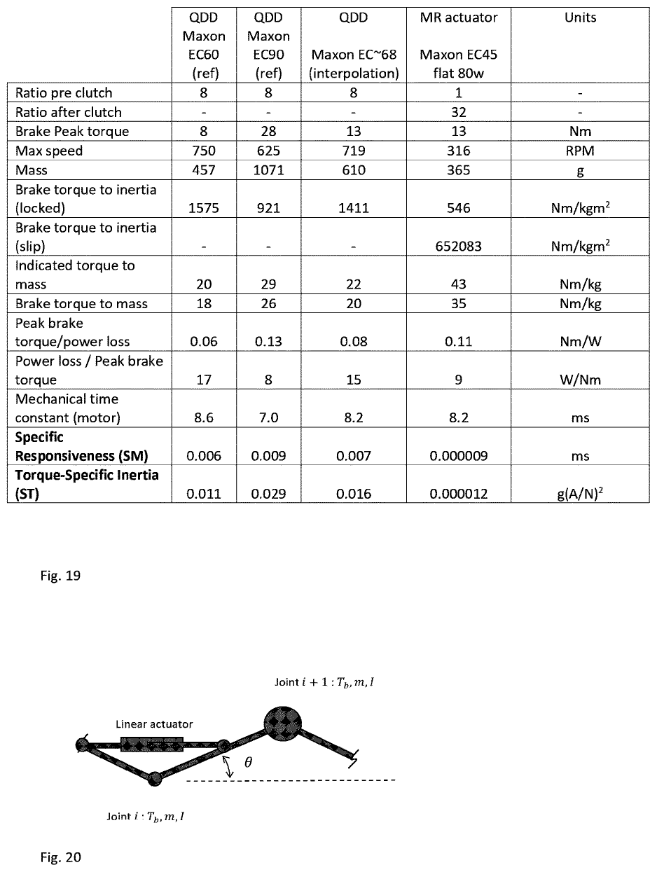

FIG. 19 shows a table comparing well detailed actuator designs to support and further illustrate results of the preceding analysis. QDD actuators of column one and two are based on existing Maxon motors and have a 8:1 total reduction ratio between the motor and the end effector. QDD actuator from column three is an interpolation of column one and two, based on a peak torque of 13 Nm and is chosen as a baseline comparison with the 13 Nm MR fluid actuator topology, as it represents the most widely used architecture in state-of-the-art proprioceptive robotics industry. Such an actuator may present a good compromise between weight (610 g) and brake torque to inertia ratio of 1411 Nm/kgm². This QDD configuration is known by experts in the field to generate heat when the actuator has to maintain a static force (e.g. to hold a payload in a given position). Increasing the gearbox ratio would contribute to decreasing the heat generated but would also penalise the torque to inertia ratio. This type of QDD proprioceptive joint may then be limited in performance.

The 4th column of FIG. 19 shows a MR proprioceptive actuator of the construction of FIG. 12. also with a peak brake torque of 13 Nm. In this MR fluid proprioceptive actuator, the total reduction ratio is 32:1. As explained before, increasing the reduction ratio of an actuator increases its torque density. Hence, the MR fluid proprioceptive actuator may have a weight of 365 g. Without the utilisation of a MR fluid clutch apparatus 10 in the kinematic chain, here represented as a MR fluid clutch apparatus 10 where the input rotor 14 is locked on the output rotor 11, the brake torque to inertia ratio of such an actuator may be of 546 Nm/kgm², so lower than the QDD configuration. This actuator, when locked, would then offer less performance than the QDD actuator of column 3 because of its higher reflected inertia. However, controlling the MR fluid clutch apparatus 10 to decouple the input rotor 14 by slippage from the output rotor 11 may allow the inertia of the input rotor 14 to be reduced at the output and hence may allow the actuator to deliver a brake torque to inertia ratio of 652083 Nm/kgm², over 400 times less than the state-of-the-art QDD actuator of column 1. Since this actuator has a higher total gearing (32:1 compared to 8:1) than the QDD, the power loss per Nm is only 9 W/Nm compared to 15 W/Nm for the QDD of column 1, even when considering the power loss in the coil of the MR fluid clutch apparatus. The MR fluid proprioceptive actuator is then lighter, offers better peak torque to inertia and has lower heat losses to maintain a payload in position.

It is to be noted here that the 10:1 ratio may be the ratio of a rotary actuator gearbox but also the ratio between the motor and the effective torque applied at a rotary joint obtained by a linear actuator connected to a lever, as shown on FIG. 20 where the first joint uses a linear actuator while a second joint is using a rotary actuator. The 10:1 ratio between the motor and the joint may also be obtained by a combination of a belt, cable and capstan, or any other combination of rotary-to-linear devices and then from a linear-to-rotary device. In such a case, the acceptable torque-to-inertia limit of 6300 N·m/kgm² is not the value at the actuator itself, but the effective limit obtained at the joint. The rotary-to-translation mechanism (e.g. lever arm, ball screw, rack and pinion, capstan and cable only to name a few) and the translation-to-rotary mechanism (e.g. lever arm, ball screw, rack and pinion, capstan and cable only to name a few) are therefore considered as part of the actuator mechanism.

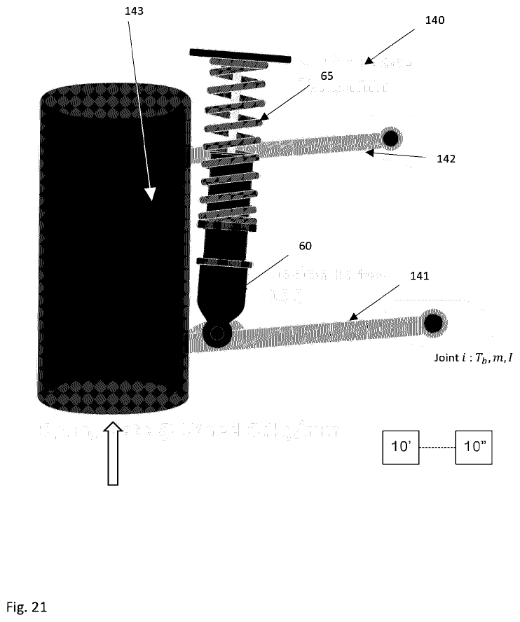

FIG. 21 shows a linear MR fluid actuator 60 with coil 65 that may be used in various wheel suspensions for suspending a wheel assembly from a sprung body of a wheeled vehicle. The MR fluid actuator 140 allows the wheel assembly to move relative to the sprung body through a bounce and rebound vertical travel, as limited by mechanical stops. The wheel assembly may be the rear wheel assembly or the front wheel assembly of a passenger vehicle such as an automobile, a front or rear wheel assembly of a motorcycle, the front or rear wheel assembly of a transportation cart, only to name a few examples. In some configurations, the relative rotational centers are disposed rearward and outboard of their respective pivots.

The active suspension system may include MR fluid actuators 140 for each wheel assembly, or only some of the wheel assemblies. In some configurations, a first structural link 141 may be coupled to the wheel assembly to define a first relative rotation center, and may be rotationally coupled to the sprung body at a first pivot, with the suspension further including a second structural link 142 coupled to the wheel assembly to define a second relative rotation center above the first relative rotation center, and rotationally coupled to the sprung body at a second pivot above the first pivot. The wheel suspension may define a geometry selected to minimize the horizontal kinetic displacement of the wheel assembly as the structural link 143 attached between any of the first or second structural 141 and 142 and the sprung body moves through an active control range over its vertical travel. In such the case of a vehicle suspension with a complex mechanism (e.g. four bar linkage), the torque-to-inertia limit of 6300 N·m/kgm² is again not the value at the actuator itself, but the effective limit obtained at the joint that is actuated, in this case the one located between the body and the first structural link 141. The wheel may be mounted to the structural link 143.

When a legged robot is mimicking human or animal motion (e.g. walking, running or jumping), the proprioceptive actuators used in legged robots may be submitted to high impacts. Since during the movement the contact time with the surface may be of limited time, any loss of control may deter the performance of the robot. Force or torque control between the limb and the surface become essential.

In the state-of-the-art QDD actuator, the actuator may have to work in the typical four quadrant of a motor. The electronics system controlling this QDD may then have to be able to power the motor but also to brake it while having a way to dissipate the energy. Dissipating energy may present some challenges. Four-quadrant electronics are known to be more expensive to produce than two quadrant system. Hence there may be an advantage in using two-quadrant electronics and dissipating the impact energy directly in the MR fluid clutch apparatus 10 by allowing some slipping between the input rotor 14 and the output rotor 11. This may lead to less costly electronics motor controller.

Another way of limiting the cost of the electronics is to install a magnet inside the MR fluid clutch apparatus while removing the electromagnetic coil. By doing this, the MR fluid clutch apparatus 10 may be used only to mitigate the impact force in the joint. The torque may only be controlled by the motor source, but all its reflected inertia will be filter-out or limited by the fluidic slipping nature of the MR fluid clutch apparatus 10.

Accordingly, the MR fluid actuator in embodiments described herein can be described as being a proprioceptive magnetorherological (MR) actuator unit between bodies, and may have a bi-directional motor assembly; a reduction mechanism having a reduction ratio greater than 10:1; a MR fluid clutch apparatus connected to the bi-directional motor assembly to transfer a variable amount of force from the bi-directional motor between at least two of the bodies using the reduction mechanism; at least one sensor for providing data indicative of a state of at least one of the bodies; a processing unit; and a non-transitory computer-readable memory communicatively coupled to the processing unit and comprising computer-readable program instructions executable by the processing unit for: receiving the data from the at least one sensor, determining from the data that the bi-directional motor assembly has to accelerate or decelerate to control a relative speed between input and output of the MR fluid clutch apparatus to transmit a desired force between the bodies, controlling the bi-directional motor to accelerate or decelerate toward the given value, and concurrently operating the MR fluid clutch apparatus to transmit the desired force between the bodies and to maintain a brake torque to inertia ratio a haptic limit, the haptic limit being for example over 6300 N·m/kgm² for an actuator with a torque of 75 Nm (Torque/(9E-6Torque^{1.66667})=6300 N·m/kgm² (i.e., 9×10⁻⁶×Torque^{1.66667}). The proprioceptive magnetorherological (MR) actuator unit may be used in robots or in active suspensions for vehicles, among other possibilities. The proprioceptive MR fluid actuator unit can be operated by the controller to reduce a torque transmission from the MR fluid clutch apparatus(es) during a perturbation caused by an impact or a contact with the environment during which the torque transmission does not correspond to the desired force achievable by the control of the motor alone, with this reduction occurring concurrently with the bi-directional motor accelerating or decelerating toward a given value. It may be said that the bi-directional motor assembly operates within a first frequency range, and the MR fluid clutch apparatus operates within a second frequency range, the second frequency range being higher than the first frequency range. The proprioceptive MR fluid actuator unit can also or alternatively be operated by the controller to provide a required torque amplitude to be generated by the bi-directional motor, with the controller keeping the bi-directional motor on even if the required torque amplitude is below a torque amplitude threshold, to store mechanical momentum in the rotating components of the actuator unit, to then activate the MR fluid clutch apparatus when the required torque amplitude is above a torque amplitude threshold to use the stored mechanical momentum. Thus, the MR fluid actuator units described herein can attain levels of brake torque to inertia by limiting the inertia associated with the weight of components, notably by having a single MR fluid clutch apparatus, relying on a single bi-directional motor for the MR fluid actuator unit to be bidirectional. The presence of a reduction mechanism allows torque ratios to be achieved while using a smaller motor, and the MR fluid clutch apparatus compensates for the lack of bandwidth of the motor.

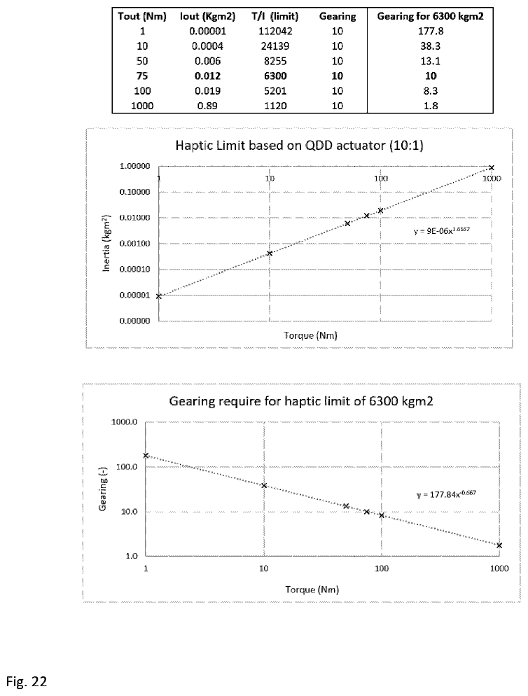

For electromechanical systems (motors, gearboxes), the torque to inertia ratio does not scale linearly. Typical scaling laws estimate that inertia scales at the power of 5/3 as a function of torque: I∝T\hat{ }(5/3). As shown in FIG. 22, the haptic limit of a QDD actuator of ˜75 Nm of torque is estimated at 6300 Nm/kgm². The haptic limit will decrease as the torque requirement is increased (e.g.: 1120 Nm/kgm² @˜1000 Nm) and inversely increase as the torque requirement decreases (e.g.: 24139 Nm/kgm²˜@10 Nm). This can also be seen in FIG. 19, where the Maxon EC90 QDD has a lower torque-to-inertia than the smaller version based on a EC60 motor. Also shown in FIG. 22, if the haptic limit is constant (e.g.: application dependant), this entails that the QDD gearing must be adapted to reach the haptic limit requirement. Assuming that the torque of an actuator increases proportionally to gearing ratio, but that the inertia of this actuator increases at the square of the gearing ratio, the torque to inertia roughly scales linearly with the gearing ratio (T/I∝gearing). In order to keep the haptic limit constant, the gearing must thus be reduced as the torque requirement of the actuator increases (e.g.: 1.8:1 at ˜1000 Nm). Inversely, the gearing can be increased as the torque requirement reduces.

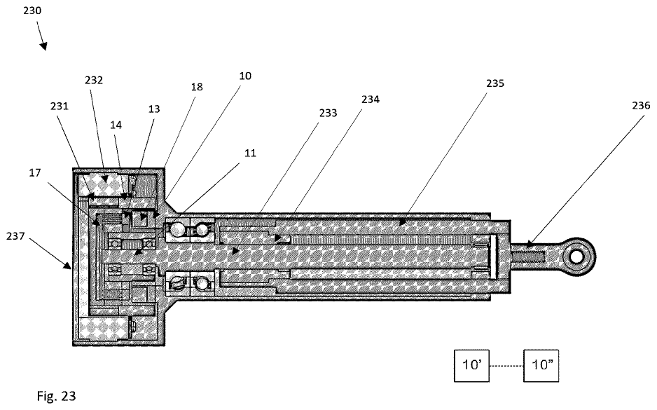

FIG. 23 shows is a schematic view of a proprioceptive linear EM actuator 230 using a MR fluid clutch apparatus 10. In this embodiment, an electric motor stator (coil) 232 powers a rotor (magnets) 231 that may be connected to the input rotor 14 defining the outer casing or shell of the MR fluid clutch apparatus 10. The output member 11 of the MR fluid clutch apparatus 10 may be connected to a screw 233. The screw 233 may be connected to a ball nut 234 (or ball screw, nut, etc) that may be used to convert the rotary torque of the actuator into a linear movement. Both ends 236 and 237 may be attached to members as shown on FIG. 20.

The advantages described for a proprioceptive robot actuator may also bring similar benefits for other applications like active vehicles suspension and seat active suspension only to name a few, where peak torque to inertia may need to be maximised.

1. A proprioceptive magnetorherological (MR) fluid actuator unit, comprising:
a bi-directional motor assembly;
a reduction mechanism having a reduction ratio greater than 10:1;
a MR fluid clutch apparatus connected to the bi-directional motor assembly, the MR fluid clutch apparatus controllable to transfer a variable amount of force from the bi-directional motor between at least two bodies using the reduction mechanism;
at least one sensor for providing data indicative of a state of at least one of the bodies;
a processing unit, and
a non-transitory computer-readable memory communicatively coupled to the processing unit and comprising computer-readable program instructions executable by the processing unit for:
receiving the data from the at least one sensor,
determining from the data that the bi-directional motor assembly has to accelerate or decelerate by a given value to control a relative speed between input and output of the MR fluid clutch apparatus to transmit a desired force between the two bodies,
controlling the bi-directional motor to accelerate or decelerate toward the given value, and
concurrently operating the MR fluid clutch apparatus to transmit the desired force between the bodies while maintaining a brake torque to inertia ratio over a haptic limit.

2. The proprioceptive MR fluid actuator unit according to claim 1, wherein the first body is a mass and the second body is a structure.

3. The proprioceptive MR fluid actuator unit according to claim 2, wherein the mass is sprung from the structure.

4. The proprioceptive MR fluid actuator unit according to claim 3, wherein the mass is controlled in order to achieve an active suspension.

5. The proprioceptive MR fluid actuator unit according to claim 1, wherein the bodies are links of a robot interconnected by a joint.

6. The proprioceptive MR fluid actuator unit according to claim 5, wherein the robot is a robot with limbs, and the links are part of the limb.

7. The proprioceptive MR fluid actuator unit according to claim 1, wherein the at least two bodies are interconnected by a rotational joint.

8. The proprioceptive MR fluid actuator unit according to claim 1, wherein the reduction mechanism includes a rotary-to-linear conversion for the proprioceptive MR fluid actuator unit to transmit a translational force between the bodies.

9. The proprioceptive MR fluid actuator unit according to claim 1, wherein the reduction mechanism includes a rotary-to-rotary arrangement for the proprioceptive MR fluid actuator unit to transmit torque between the bodies.

10. The proprioceptive MR fluid actuator unit according to claim 1, wherein the computer-readable program instructions are executable by the processing unit for causing a slippage in the MR fluid clutch apparatus at a brake torque to inertia ratio over the haptic limit.

11. The proprioceptive MR fluid actuator unit according to claim 1, wherein the haptic limit in N·m/kgm² is equal to Torque/(9×10⁻⁶×Torque^{1.6666}) for a torque in Nm for the proprioceptive MR fluid actuator unit.

12. The proprioceptive MR fluid actuator unit according to claim 1, wherein the haptic limit is 6300 N·m/kgm² for a torque of 75 Nm for the actuator unit.

13. The proprioceptive MR fluid actuator unit according to claim 1, wherein the MR fluid clutch apparatus has a torque-to-inertia ratio of at least 1×10⁶ N·m/kg·m².

14. The proprioceptive MR fluid actuator unit according to claim 1, wherein the reduction mechanism has a contact ratio of at least two between torque transferring elements.

15. The proprioceptive MR fluid actuator unit according to claim 14, wherein the reduction mechanism includes multiple load paths.

16. The proprioceptive MR fluid actuator unit according to claim 15, wherein the reduction mechanism is epicyclic gearing with at least two planets.
